(19) United States
(12) Patent Application Publication
(10) Pub. No.: US 2026/0011333 A1
(43) Pub. Date: Jan. 8, 2026

(54) SPEECH RECOGNITION DEVICE, SPEECH RECOGNITION METHOD, AND PROGRAM

(71) Applicant: NEC Corporation, Tokyo (JP)

(72) Inventor: Shuji KOMEIJI, Tokyo (JP)

(73) Assignee: NEC Corporation, Tokyo (JP)

(21) Appl. No.: 19/324,688

(22) Filed: Sep. 10, 2025

Related U.S. Application Data
(63) Continuation of application No. 17/760,847, filed on Mar. 16, 2022.

(30) Foreign Application Priority Data
Sep. 27, 2019 (JP) 2019-176484

(51) Int. Cl. G10L 17/22; G06F 40/166; G10L 17/02; G10L 17/04

(52) U.S. Cl. CPC G10L 17/22; G06F 40/166; G10L 17/02; G10L 17/04

(57) ABSTRACT

A speech recognition apparatus (100) includes: a speech reproduction unit (102) that reproduces, for each predetermined section, target speech for speech recognition being divided for each predetermined section; a speech recognition unit (104) that recognizes, for each target speech, spoken speech acquired by repeating the target speech by a user; a text information generation unit (106) that generates text information about the spoken speech, based on a recognition result of the speech recognition unit (104); and a storage processing unit (108) that stores, as learning data, identification information by the user, the spoken speech, and the recognition result corresponding to the spoken speech in association with one another, in which the speech recognition unit (104) performs recognition by using a recognition engine that learns the learning data by the user.

This application is a continuation application of U.S. patent application Ser. No. 17/760,847 filed on Mar. 16, 2022, which is a National Stage Entry of PCT/JP2020/033974 filed on Sep. 8, 2020, which claims priority from Japanese Patent Application 2019-176484 filed on Sep. 27, 2019, the contents of all of which are incorporated herein by reference, in their entirety.

### TECHNICAL FIELD

The present invention relates to a speech recognition apparatus, a speech recognition method, and a program.

### BACKGROUND ART

One example of an apparatus that produces a subtitle from speech is described in Patent Document 1. In the apparatus according to Patent Document 1, a speech recognition unit performs speech recognition on target speech or speech acquired by repeating target speech and converts the speech into text, and a text division/connection unit generates a subtitle text by performing division processing on the text after the speech recognition.

Further, Patent Document 2 describes that a mobile phone transmits speech information input from a microphone is converted into text information by using a speech/text conversion unit, and the text information by using a text transmission unit, and, furthermore, outputs text information received by a text reception unit is converted into speech information by using a text/speech conversion unit, and the speech information from a speaker.

### RELATED DOCUMENT

### Patent Document

[Patent Document 1] Japanese Patent Application Publication No. 2017-40806
[Patent Document 2] Japanese Patent Application Publication No. 2007-114582

### SUMMARY OF THE INVENTION

### Technical Problem

When speech is repeated, an individual difference may occur in a feature of the repeated speech. Thus, when speech repeated by an annotator is recognized, a variation in recognition accuracy may occur. Thus, speech recognition accuracy may not be sufficiently improved in transcription of speech.

The present invention has been made in view of the circumstance described above, and provides a technique for improving speech recognition accuracy in transcription of speech.

### Solution to Problem

In each aspect according to the present invention, each configuration below is adopted in order to solve the above-mentioned problem.

A first aspect relates to a speech recognition apparatus.

The speech recognition apparatus according to the first aspect, including:
a speech reproduction unit that reproduces, for each predetermined section, target speech for speech recognition being divided for each of the predetermined sections;
a speech recognition unit that recognizes, for each of pieces of the target speech, spoken speech acquired by repeating the target speech by a user;
a text information generation unit that generates text information about the spoken speech, based on a recognition result of the speech recognition unit; and
a storage unit that stores, as learning data, identification information by the user, the spoken speech, and the recognition result corresponding to the spoken speech in association with one another, wherein
the speech recognition unit performs recognition by using a recognition engine that learns the learning data by the user.

A second aspect relates to a speech recognition method executed by at least one computer.

The speech recognition method according to the second aspect, including:
by a speech recognition apparatus,
reproducing, for each predetermined section, target speech for speech recognition being divided for each of the predetermined sections;
recognizing, for each of pieces of the target speech, spoken speech acquired by repeating the target speech by a user;
generating text information about the spoken speech, based on a recognition result of the spoken speech;
storing, as learning data, identification information by the user, the spoken speech, and the recognition result corresponding to the spoken speech in association with one another; and,
when recognizing the spoken speech, recognizing by using a recognition engine that learns the learning data by the user.

Note that, another aspect according to the present invention may be a program causing at least one computer to execute the method in the second aspect, or may be a computer-readable storage medium that records such a program. The storage medium includes a non-transitory tangible medium.

The computer program includes a computer program code causing a computer to execute the speech recognition method on the speech recognition apparatus when the computer program code is executed by the computer.

Note that, any combination of the components above and an expression of the present invention being converted among an apparatus, a system, a storage medium, a computer program, and the like are also effective as a manner of the present invention.

Further, various components according to the present invention do not necessarily need to be an individually independent presence, and a plurality of components may be formed as one member, one component may be formed of a plurality of members, a certain component may be a part of another component, a part of a certain component and a part of another component may overlap each other, and the like.

Further, a plurality of procedures are described in an order in the method and the computer program according to the present invention, but the described order does not limit an order in which the plurality of procedures are executed. Thus, when the method and the computer program according to the present invention are executed, an order of the plurality of procedures can be changed within an extent that there is no harm.

Furthermore, a plurality of procedures of the method and the computer program according to the present invention are not limited to being executed at individually different timings. Thus, another procedure may occur during execution of a certain procedure, an execution timing of a certain procedure and an execution timing of another procedure may partially or entirely overlap each other, and the like.

### Advantageous Effects of Invention

Each of the aspects described above can provide a technique for improving speech recognition accuracy in transcription of speech.

### BRIEF DESCRIPTION OF THE DRAWINGS

FIG. 1 is a block diagram schematically illustrating a configuration example of a speech recognition system according to an example embodiment of the present invention.

FIG. 2 is a functional block diagram illustrating a logical configuration example of a speech recognition apparatus according to the example embodiment of the present invention.

FIG. 3 is a block diagram illustrating a hardware configuration of a computer that achieves the speech recognition apparatus illustrated in FIG. 2.

FIG. 4 is a flowchart illustrating one example of an operation of the speech recognition apparatus according to the present example embodiment.

FIG. 5 is a diagram for describing a relationship of information in the speech recognition apparatus according to the present example embodiment.

FIG. 6 is a diagram illustrating one example of a data structure of learning data according to the present example embodiment.

FIG. 7 is a flowchart illustrating one example of an operation of the speech recognition apparatus according to the present example embodiment.

FIG. 8 is a diagram for describing a relationship of information in the speech recognition apparatus according to the present example embodiment.

FIG. 9 is a flowchart illustrating another operation example of the speech recognition apparatus according to the present example embodiment.

FIG. 10 is a flowchart illustrating still another operation example of the speech recognition apparatus according to the present example embodiment.

FIG. 11 is a diagram illustrating one example of a data structure of the learning data according to the present example embodiment.

FIG. 12 is a flowchart illustrating an operation example of the speech recognition apparatus according to the present example embodiment.

FIGS. 13A and 13B are diagrams each illustrating an example of a data structure of the learning data according to the present example embodiment.

FIG. 14 is a functional block diagram illustrating a functional configuration example of the speech recognition apparatus according to the present example embodiment.

FIG. 15 is a flowchart illustrating an operation example of the speech recognition apparatus according to the present example embodiment.

FIG. 16 is a functional block diagram illustrating a functional configuration example of the speech recognition apparatus according to the present example embodiment.

FIG. 17 is a flowchart illustrating an operation example of the speech recognition apparatus according to the present example embodiment.

### DESCRIPTION OF EMBODIMENTS

Hereinafter, example embodiments according to the present invention will be described with reference to drawings. Note that, in all of the drawings, a similar component has a similar reference sign, and description thereof will be appropriately omitted. In each of the following drawings, a configuration of a portion unrelated to essence of the present invention is omitted and not illustrated.

“Acquisition” in an example embodiment includes at least one of acquisition (active acquisition), by its own apparatus, of data or information being stored in another apparatus or a storage medium, and inputting (passive acquisition) of data or information output from another apparatus to its own apparatus. Examples of the active acquisition include reception of a reply to a request or an inquiry by making the request or the inquiry to another apparatus, reading by accessing another apparatus or a storage medium, and the like. Further, examples of the passive acquisition include reception of information distributed (transmitted, push-notified, or the like), and the like. Furthermore, “acquisition” may include acquisition by selection from among pieces of received data or pieces of received information, or reception by selecting distributed data or distributed information.

### First Example Embodiment

### <System Overview>

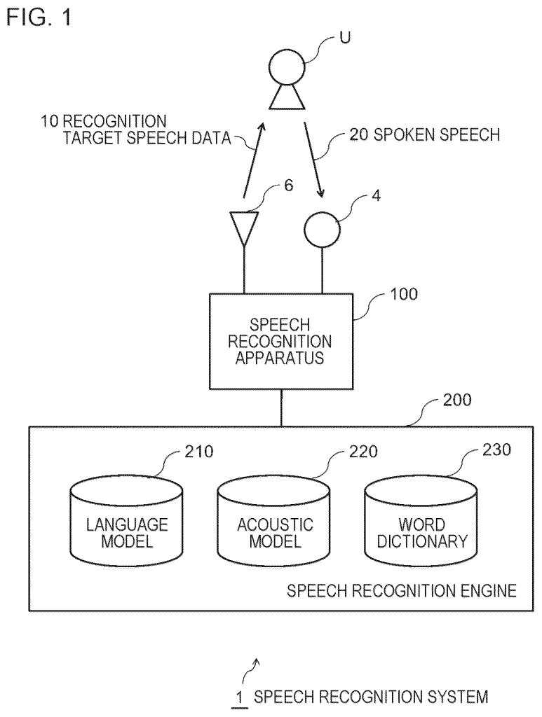

FIG. 1 is a block diagram schematically illustrating a configuration example of a speech recognition system 1 according to an example embodiment of the present invention. The speech recognition system 1 according to the present example embodiment is a system for transcribing speech into text. The speech recognition system 1 includes a speech recognition apparatus 100, a speech input unit such as a microphone 4, and a speech output unit such as a speaker 6. The speaker 6 is preferably headphones mounted on a user U, or the like in such a way that output speech is not input to the microphone 4, which is not limited thereto. In the speech recognition system 1, the user U catches original speech (hereinafter also referred to as recognition target speech data 10) being a speech recognition target output from the speaker 6, spoken speech 20 repeated by the user U is input from the microphone 4, the speech recognition apparatus 100 performs speech recognition processing, and generates text information (hereinafter also referred to as text data 30).

The speech recognition apparatus 100 includes a speech recognition engine 200. The speech recognition engine 200 includes various models, for example, a language model 210, an acoustic model 220, and a word dictionary 230. The speech recognition apparatus 100 recognizes, by using the speech recognition engine 200, the spoken speech 20 acquired by repeating the recognition target speech data 10 by the user U, and outputs the text data 30 as a recognition result. In the present example embodiment, each of the models used in the speech recognition engine 200 is provided for each speaker.

There is a possibility that sound quality may not satisfy a level that permits application to speech recognition since the original recognition target speech data 10 vary in pronunciation, rate, volume, and the like depending on a person who makes speech, each person has a habit, and there are various recording environments (such as a surrounding environment, recording equipment, and a type of recording data). Thus, recognition accuracy decreases, and false recognition occurs. Then, the user U referred to as an annotator listens to the original recognition target speech data 10 output from the speaker 6, and thus repeats a speech content included in the listened recognition target speech data 10. The speech recognition apparatus 100 recognizes, under a certain condition, the spoken speech 20 repeated by the user U. The user U preferably repeats speech (makes speech) in such a way that a speaking rate, vocalization, and the like satisfy standards suitable for speech recognition. However, an individual difference is more likely to occur in speech during repetition, and recognition accuracy also varies. Thus, the speech recognition apparatus 100 according to the present example embodiment learns a feature and a habit of spoken speech of an annotator. In this way, recognition accuracy by the speech recognition apparatus 100 increases.

### <Functional Configuration Example>

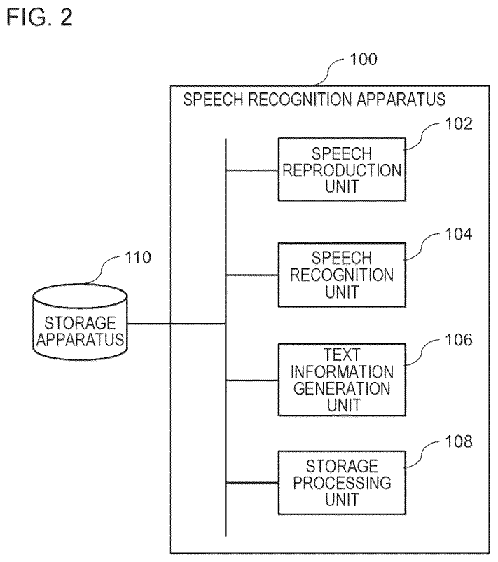

FIG. 2 is a functional block diagram illustrating a logical configuration example of the speech recognition apparatus 100 according to the example embodiment of the present invention.

The speech recognition apparatus 100 includes a speech reproduction unit 102, a speech recognition unit 104, a text information generation unit 106, and a storage processing unit 108.

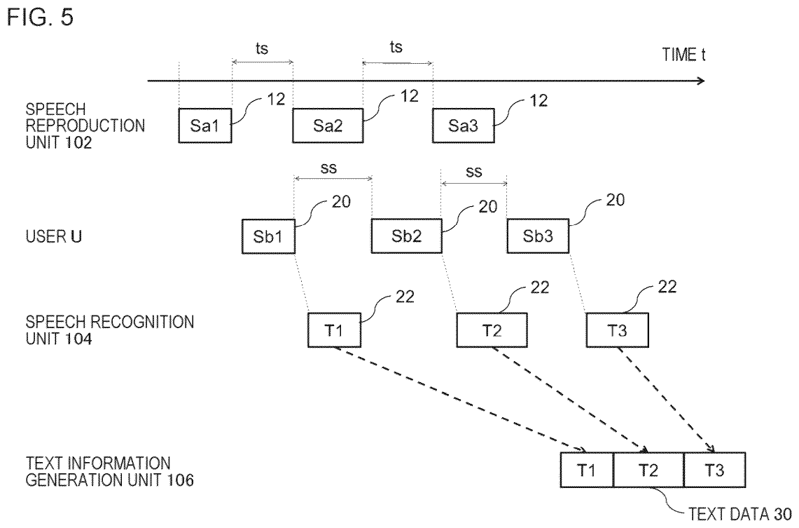

The speech reproduction unit 102 reproduces, for the user U for each predetermined section, original target speech (hereinafter also referred to as section speech 12 (see FIG. 5)) for speech recognition being divided for each predetermined section.

The speech recognition unit 104 recognizes, for each section speech 12, the spoken speech 20 acquired by repeating the section speech 12 by the user U. In the recognition, the speech recognition unit 104 uses a model by user U, for example, the language model 210, the acoustic model 220, and the word dictionary 230 by user U. Each of the models by user U is stored in a storage apparatus 110, for example.

The text information generation unit 106 generates text information (the text data 30) about the spoken speech 20 recognized by the speech recognition unit 104.

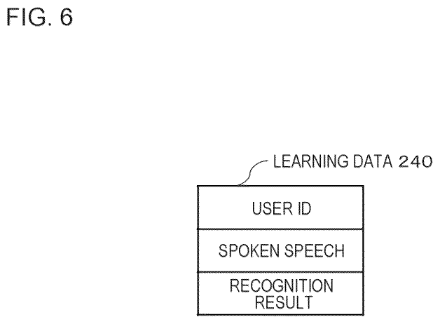

The storage processing unit 108 stores, as learning data 240 (FIG. 6), identification information (indicated as a user ID in the diagram) by user U, the spoken speech 20, and a recognition result corresponding to the spoken speech 20 in association with one another in the storage apparatus 110.

### <Hardware Configuration Example>

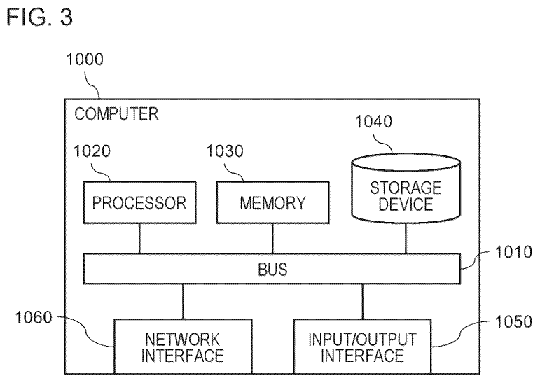

FIG. 3 is a block diagram illustrating a hardware configuration of a computer 1000 that achieves the speech recognition apparatus 100 illustrated in FIG. 2. The computer 1000 includes a bus 1010, a processor 1020, a memory 1030, a storage device 1040, an input/output interface 1050, and a network interface 1060.

The bus 1010 is a data transmission path for allowing the processor 1020, the memory 1030, the storage device 1040, the input/output interface 1050, and the network interface 1060 to transmit and receive data to and from one another. However, a method of connecting the processor 1020 and the like to each other is not limited to bus connection.

The processor 1020 is a processor achieved by a central processing unit (CPU), a graphics processing unit (GPU), and the like.

The memory 1030 is a main storage apparatus achieved by a random access memory (RAM) and the like.

The storage device 1040 is an auxiliary storage apparatus achieved by a hard disk drive (HDD), a solid state drive (SSD), a memory card, a read only memory (ROM), or the like. The storage device 1040 stores a program module that achieves each function of the computer 1000. The processor 1020 reads each program module onto the memory 1030 and executes the program module, and each function associated with the program module is achieved. Further, the storage device 1040 also stores each model of the speech recognition engine 200.

The program module may be stored in a storage medium. The storage medium that records the program module may include a non-transitory tangible medium usable by the computer 1000, and a program code readable by the computer 1000 (the processor 1020) may be embedded in the medium.

The input/output interface 1050 is an interface for connecting the computer 1000 and various types of input/output equipment.

The network interface 1060 is an interface for connecting the computer 1000 to a communication network. The communication network is, for example, a local area network (LAN) and a wide area network (WAN). A method of connection to the communication network by the network interface 1060 may be wireless connection or wired connection.

Then, the computer 1000 is connected to necessary equipment (for example, the microphone 4 and the speaker 6) via the input/output interface 1050 or the network interface 1060.

The computer 1000 that achieves the speech recognition apparatus 100 is, for example, a personal computer, a smartphone, a tablet terminal, or the like. Alternatively, the computer 1000 that achieves the speech recognition apparatus 100 may be a dedicated terminal apparatus. For example, the speech recognition apparatus 100 is achieved by installing an application program for achieving the speech recognition apparatus 100 in the computer 1000 and activating the application program.

In another example, the computer 1000 may be a Web server, and a user may activate a browser on a user terminal such as a personal computer, a smartphone, and a tablet terminal and may access a Web page providing a service of the speech recognition apparatus 100 via a network such as the Internet, and thus a function of the speech recognition apparatus 100 may be able to be used.

In still another example, the computer 1000 may be a server apparatus of a system such as Software as a Service (SaaS) providing a service of the speech recognition apparatus 100. A user may access a server apparatus from a user terminal such as a personal computer, a smartphone, and a tablet terminal via a network such as the Internet, and the speech recognition apparatus 100 may be achieved by a program operating on the server apparatus.

### <Operation Example>

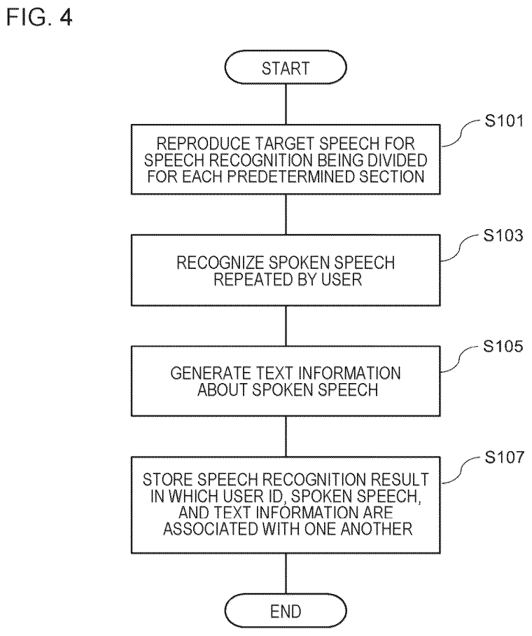

FIG. 4 is a flowchart illustrating one example of an operation of the speech recognition apparatus 100 according to the present example embodiment. FIG. 5 is a diagram for describing a relationship of information in the speech recognition apparatus 100 according to the present example embodiment.

First, the speech reproduction unit 102 reproduces original target speech for speech recognition being divided for each predetermined section (step S101). Specifically, the speech reproduction unit 102 divides the recognition target speech data 10 into predetermined sections, and outputs the divided recognition target speech data 10 to the speaker 6. Sa1, Sa2, and Sa3 in FIG. 5 are each section speech 12.

The predetermined section is, for example, a section including at least any one of a sentence, a phrase, and a word included in speech being a recognition target. A plurality of sentences, phrases, and words may be included in each section. The number of sentences, phrases, and words included in each section may not be fixed. A predetermined time interval ts is placed between speech sections. The predetermined time interval ts may be fixed, or may not be fixed. The speech reproduction unit 102 reproduces the section speech 12 by dividing the recognition target speech data 10 for each section including any one of a sentence, a phrase, and a word. It may be silent or a predetermined notification sound may be output between pieces of the section speech 12.

The speech recognition unit 104 recognizes the section speech 12 by using the speech recognition engine 200 including the language model 210, the acoustic model 220, and the word dictionary 230. As described above, the speech recognition apparatus 100 stores, by user U, each model (for example, the language model 210, the acoustic model 220, and the word dictionary 230) used in the speech recognition engine 200. Each model is generated by learning speech of the associated user U and a recognition result thereof. Thus, a feature and a habit of speech of the associated user U are reflected in each model. Learning of a model will be described in an example embodiment described below.

Each model is associated with a user ID that identifies the user U. The speech recognition unit 104 makes preparation by acquiring the user ID of the user U prior to speech recognition processing, and reading the speech recognition engine 200 associated with the acquired user ID. A method of acquiring a user ID is exemplified below. Note that, biometric information such as a voiceprint may be used instead of a user ID.
(1) When an application of the speech recognition apparatus 100 is activated, the user U is caused to input the user ID from an operation screen.
(2) When the user U accesses a Web page or a server of SaaS providing a service of the speech recognition apparatus 100, the user U is caused to input the user ID and a password for user authentication from a screen for logging into a system.
(3) Identification information (for example, User IDentifier (UID), International Mobile Equipment Identity (IMEI), or the like) about a portable terminal that activates the speech recognition apparatus 100 is acquired as a user ID.
(4) After an application of the speech recognition apparatus 100 is activated, or after a Web page or a server is accessed, a list of users who are registered in advance is displayed, and the user U is caused to make a selection. A user ID associated with a user in advance is acquired.

Then, the speech recognition unit 104 recognizes the spoken speech 20 repeated by the user U (step S103). The spoken speech 20 of the user U is input to the speech recognition unit 104 via the microphone 4. The user U listens to the section speech 12 reproduced by the speech reproduction unit 102, and repeats the speech. The user U repeats the speech every time the user U listens to the section speech 12. Sb1, Sb2, and Sb3 in FIG. 5 are each spoken speech 20.

The speech recognition unit 104 detects a silence section ss between pieces of the spoken speech 20 repeated by the user U, and thus detects a section of each spoken speech 20 to be input. The speech recognition unit 104 recognizes each detected spoken speech 20, and passes a recognition result 22 to the text information generation unit 106. T1, T2, and T3 in FIG. 5 are each recognition result 22.

Then, the text information generation unit 106 generates text information (the text data 30) about the spoken speech 20 (step S105). The text information generation unit 106 successively acquires, from the speech recognition unit 104, the recognition result 22 of the spoken speech 20 associated with each section speech 12, connects the recognition results 22, and generates the text data 30 associated with a series of the spoken speech 20.

The recognition result 22 acquired from the speech recognition unit 104 may include information such as likelihood. The text information generation unit 106 connects the recognition result 22 associated with the spoken speech 20 of each section speech 12 by using the language model 210 and the word dictionary 230, creates a sentence, and generates the text data 30. For example, the text data 30 are a file in text format in which a created sentence is described.

Then, the storage processing unit 108 stores, as the learning data 240, the spoken speech 20 and the recognition result 22 by user U in association with each other in the storage apparatus 110 (step S107).

FIG. 6 is a diagram illustrating one example of a data structure of the learning data 240. The learning data 240 stores identification information (user ID) about the user U, the spoken speech 20, and the recognition result 22 in association with one another.

The speech recognition engine 200 for each user U is caused to perform machine learning by using the learning data 240 for each user U, and thus can match a speech feature of the user U.

According to the present example embodiment, the speech recognition unit 104 can perform speech recognition by using the speech recognition engine 200 that learns a speech feature for each user U, and can thus improve recognition accuracy.

### Second Example Embodiment

A speech recognition apparatus 100 according to the present example embodiment is the same as that in the example embodiment described above except for a point that the speech recognition apparatus 100 according to the present example embodiment has a configuration for performing processing in response to a state of repetition by a user U when repetition by the user U does not catch up with speech reproduction by a speech reproduction unit 102, and the like. Since the speech recognition apparatus 100 according to the present example embodiment has the same configuration as that of the speech recognition apparatus 100 in FIG. 2, description is given by using FIG. 2.

### <Functional Configuration Example>

When a speech recognition unit 104 does not recognize spoken speech 20 repeated by a user within a fixed time, the speech reproduction unit 102 interrupts reproduction of section speech 12, and then restarts the reproduction of the section speech 12being a section at a point in time before a point in time at which the reproduction is interrupted.

Furthermore, the speech reproduction unit 102 does not interrupt reproduction of the section speech 12 when the spoken speech 20 repeated by the user U is not recognized in a section different from a section in which the section speech 12 made by division in advance is reproduced.

Herein, the section different from the section in which the section speech 12 made by division in advance is reproduced is, for example, a non-reproduction section between a plurality of pieces of the section speech 12 reproduced by dividing recognition target speech data 10. As described above, an interval of the non-reproduction section is a time interval ts.

Furthermore, the speech reproduction unit 102 changes a reproduction rate of target speech (section speech 12) in a certain section in response to a speech input rate when the spoken speech 20 repeated by the user U is input to a section before the certain section.

A method of controlling a reproduction rate is exemplified below, which is not limited thereto. For example, the speech reproduction unit 102 makes a reproduction rate slower than a predetermined rate when an input rate of the spoken speech 20 is slower than the predetermined rate, and makes the reproduction rate faster than the predetermined rate when the input rate of the spoken speech 20 is faster than the predetermined rate. Alternatively, the speech reproduction unit 102 may reproduce original speech (section speech 12) being a recognition target at the same rate as an input rate of the spoken speech 20.

### <Operation Example>

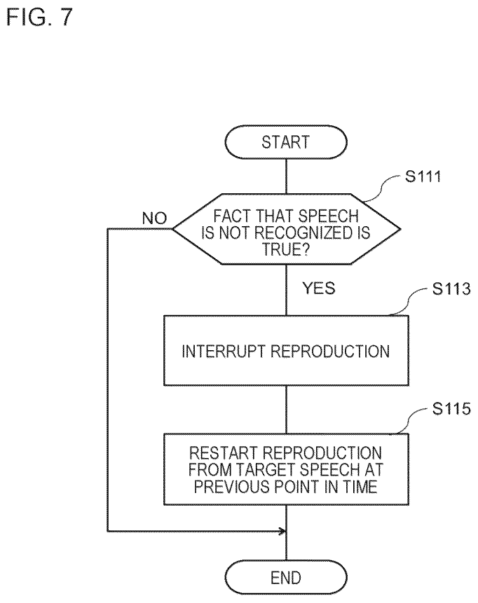

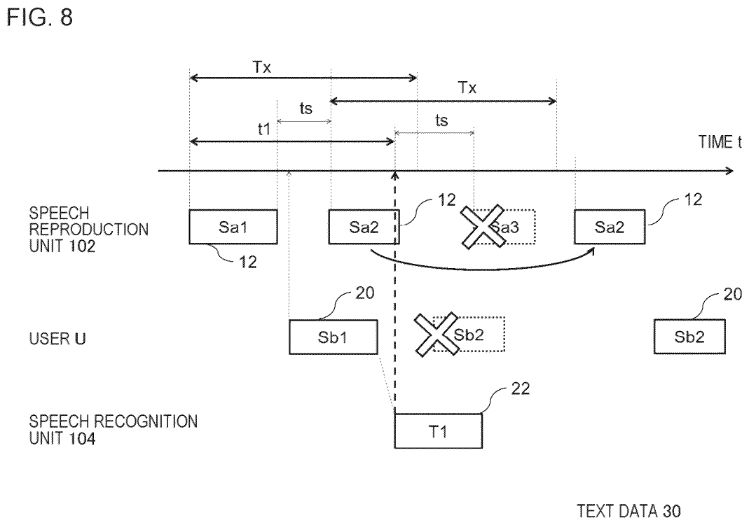

FIG. 7 is a flowchart illustrating one example of an operation of the speech recognition apparatus 100 according to the present example embodiment. FIG. 8 is a diagram for describing a relationship of information in the speech recognition apparatus 100 according to the present example embodiment.

For example, the flowchart in FIG. 7 operates every time the speech reproduction unit 102 outputs each section speech 12 of the recognition target speech data 10 in step S101 in FIG. 5.

First, the speech reproduction unit 102 determines whether the speech recognition unit 104 recognizes the spoken speech 20 repeated by a user within a fixed time (step S111). The determination method is exemplified below.
(1) The speech recognition unit 104 notifies the speech reproduction unit 102 of recognition every time the speech recognition unit 104 recognizes the spoken speech 20 of the user U (when the speech recognition unit 104 detects the spoken speech 20 or generates a recognition result 22). The speech reproduction unit 102 measures a time interval of notification from the speech recognition unit 104, and determines whether the notification falls within a fixed time Tx.
(2) The speech recognition unit 104 notifies the speech reproduction unit 102 of recognition every time the speech recognition unit 104 recognizes the spoken speech 20 of the user U. When the speech reproduction unit 102 acquires the notification within the fixed time Tx since a point in time (a reproduction start or a reproduction end) at which the section speech 12 is reproduced, the speech reproduction unit 102 determines that the spoken speech 20 is recognized, and, when the speech reproduction unit 102 does not acquire the notification within the fixed time Tx, the speech reproduction unit 102 determines that the spoken speech 20 is not recognized.
(3) When the speech recognition unit 104 cannot recognize next spoken speech 20 within the fixed time Tx since a point in time at which the spoken speech 20 repeated by the user U is recognized the previous time, the speech recognition unit 104 notifies the speech reproduction unit 102 of this fact. Herein, the point in time at which the spoken speech 20 is recognized is, for example, either a point in time at which an input of the spoken speech 20 is detected or a point in time at which the recognition result 22 of the spoken speech 20 is generated.
(4) The speech reproduction unit 102 makes an inquiry of the speech recognition unit 104 about whether the spoken speech 20 can be recognized after a lapse of a fixed time since a point in time (a reproduction start or a reproduction end) at which the section speech 12 is reproduced.
(5) The speech reproduction unit 102 detects in the speech recognition unit 104 whether there is an input of the spoken speech 20 of the user U from the microphone 4 within the fixed time Tx since a point in time (a reproduction start or a reproduction end) at which the section speech 12 is reproduced. The speech reproduction unit 102 determines that the spoken speech 20 is recognized when there is an input of the spoken speech 20, and determines that the spoken speech 20 is not recognized when there is no input.

Then, when the speech recognition unit 104 does not recognize the spoken speech 20 repeated by a user within the fixed period of time Tx (YES in step S111), the speech reproduction unit 102 interrupts reproduction of the section speech 12 (step S113). For example, in the example in FIG. 8, the speech recognition unit 104 generates the recognition result 22 of T1 at a time t1, which is within the fixed time Tx since a point in time at which the speech reproduction unit 102 starts reproduction of the section speech 12 of Sa1. Thus, the speech reproduction unit 102 reproduces the section speech 12 of Sa2 in a next section.

However, in the example in FIG. 8, even after a lapse of the fixed time Tx since a point in time at which reproduction of the section speech 12 of Sa2 starts, the user U cannot repeat the spoken speech 20, and thus the recognition result 22 cannot be acquired from the speech recognition unit 104. Thus, the speech reproduction unit 102 interrupts reproduction of the section speech 12 of Sa3.

Then, the speech reproduction unit 102 restarts the reproduction of the section speech 12 from a point in time before a point in time at which the reproduction is interrupted (step S115). In the example in FIG. 8, the speech reproduction unit 102 reproduces again the previous section speech 12 of Sa2 after the reproduction of the section speech 12 of Sa3 is interrupted. Then, the user U repeats the section speech 12 of Sa2. Then, the speech recognition unit 104 can recognize the spoken speech 20 of Sb2.

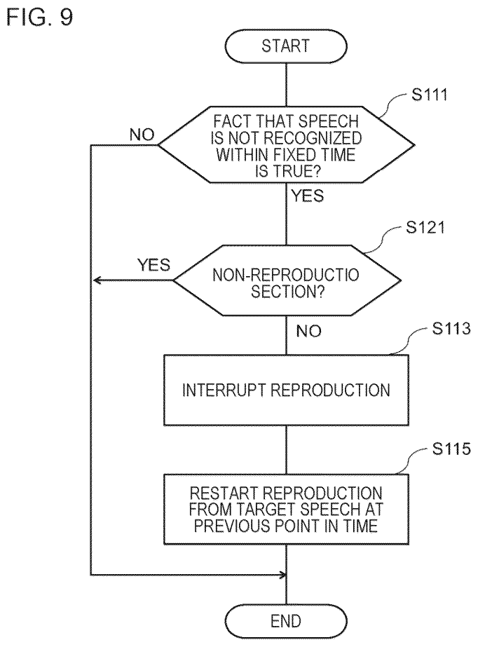

FIG. 9 is a flowchart illustrating another operation example of the speech recognition apparatus 100 according to the present example embodiment.

The flowchart in FIG. 9 includes step S121 between step S111 and step S113 in the flowchart in FIG. 7.

When the spoken speech 20 repeated by the user U is not recognized (YES in step S111), the processing bypasses step S113 and step S115 in a section (non-reproduction section) different from a section in which the section speech 12 made by division in advance is reproduced (YES in step S121), and the speech reproduction unit 102 does not interrupt reproduction of the section speech 12.

When the spoken speech 20 repeated by the user U is not recognized (YES in step S111), and it is not a section (non-reproduction section) different from the section in which the section speech 12 made by division in advance is reproduced (NO in step S121), the processing proceeds to step S113, and the speech reproduction unit 102 interrupts reproduction of the section speech 12.

Further, as another example, the speech reproduction unit 102 may measure time of a non-reproduction section between pieces of the reproduced section speech 12 in step S111, and perform determination by adding the time interval ts of the non-reproduction section to the fixed time Tx.

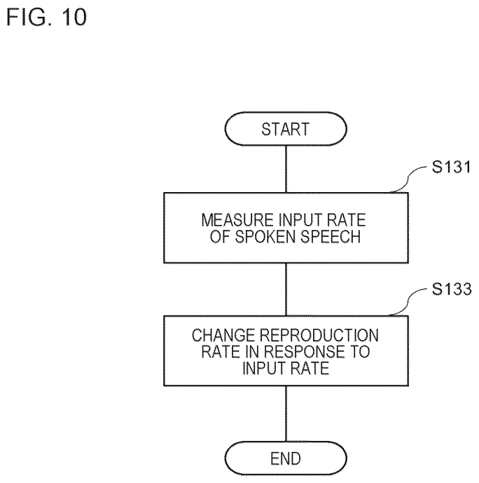

FIG. 10 is a flowchart illustrating still another operation example of the speech recognition apparatus 100 according to the present example embodiment. The flowchart in FIG. 10 operates at all times, on a regular basis, when being requested, or the like.

First, the speech reproduction unit 102 measures an input rate of the spoken speech 20 input to the microphone 4 (step S131). The input rate is, for example, at least any one of the number of words, the number of characters, and the number of phonemes within a unit time.

Then, the speech reproduction unit 102 adjusts a reproduction rate according to the input rate of the spoken speech 20 (step S133). Similarly to the input rate, the reproduction rate is also, for example, at least any one of the number of words, the number of characters, and the number of phonemes within a unit time. Then, the speech reproduction unit 102 adjusts the reproduction rate to the input rate of the spoken speech 20 or slower, and reproduces the section speech 12.

The present example embodiment can achieve an effect similar to that in the example embodiment described above, and, furthermore, the speech reproduction unit 102 can also control reproduction of the section speech 12 in response to a speech recognition state and an input rate of the spoken speech 20, and thus, even when repetition by the user U cannot catch up, an operation can be smoothly restored without getting delayed. Furthermore, the present example embodiment can match a reproduction rate with a rate of repetition by the user U, and thus, even when a rate of speaking of the user U is fast or slow, reproduction of the section speech 12 can be appropriately adjusted. In this way, the user U can pleasantly continue an operation without repetition by the user U not catching up and having too much time.

### Third Example Embodiment

A speech recognition apparatus 100 according to the present example embodiment is the same as that in any of the example embodiments described above except for a point that the speech recognition apparatus 100 according to the present example embodiment has a configuration in which machine learning is performed on a recognition result of spoken speech 20 of a user U. The speech recognition apparatus 100 according to the present example embodiment will be described by using FIG. 2.

### <Functional Configuration Example>

A storage processing unit 108 stores, as learning data 240, section speech 12 in a predetermined section in association with the spoken speech 20 repeated by the user U after a speech reproduction unit 102 reproduces the section speech 12 in the predetermined section.

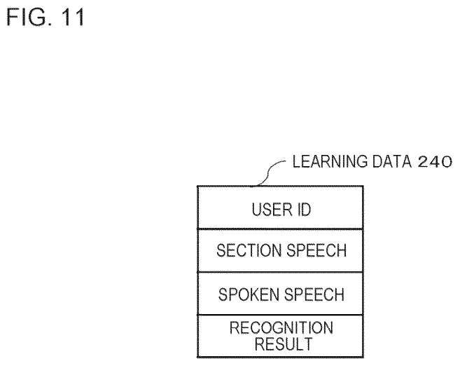

FIG. 11 is a diagram illustrating one example of a data structure of the learning data 240 according to the present example embodiment. The learning data 240 in FIG. 11 further store the section speech 12 in association in addition to the learning data 240 in FIG. 6.

The learning data 240 generated in such a manner are used for machine learning of a speech recognition engine 200 by user U.

The present example embodiment can achieve an effect similar to that in the example embodiment described above, and can further construct the speech recognition engine 200 specialized in the user U by causing each model of the speech recognition engine 200 by user U to perform machine learning by using the learning data 240 by user U being generated in such a manner.

### Fourth Example Embodiment

A speech recognition apparatus 100 according to the present example embodiment is the same as that in any of the example embodiments described above except for a point that the speech recognition apparatus 100 according to the present example embodiment has a configuration in which a first language and a second language translated from the first language are repeated and speech information is transcribed into text.

### <Functional Configuration Example>

After a speech reproduction unit 102 reproduces speech recognition target speech in a first language (for example, English), a speech recognition unit 104 performs speech recognition on each of the spoken speech in the first language being repeated and spoken speech 20 spoken by translating the first language into a second language (for example, Japanese).

A text information generation unit 106 generates text data 30 about each of the spoken speech 20 in the first language and the spoken speech 20 in the second language, based on a recognition result by the speech recognition unit 104.

A storage processing unit 108 stores, in association with one another, the spoken speech 20 in the first language being repeated by the user U, the spoken speech 20 in the second language, and section speech 12 in the first language being reproduced by the speech reproduction unit 102.

In the present example embodiment, description is given on an assumption that the first language is English and the second language is Japanese. In another example, the first language may be a dialect (for example, the Osaka dialect) and the second language may be a standard language, or, on the contrary, the first language may be a standard language and the second language may be a dialect. In still another example, the first language may be an honorific language and the second language may be other than the honorific language, or vice versa.

### <Operation Example>

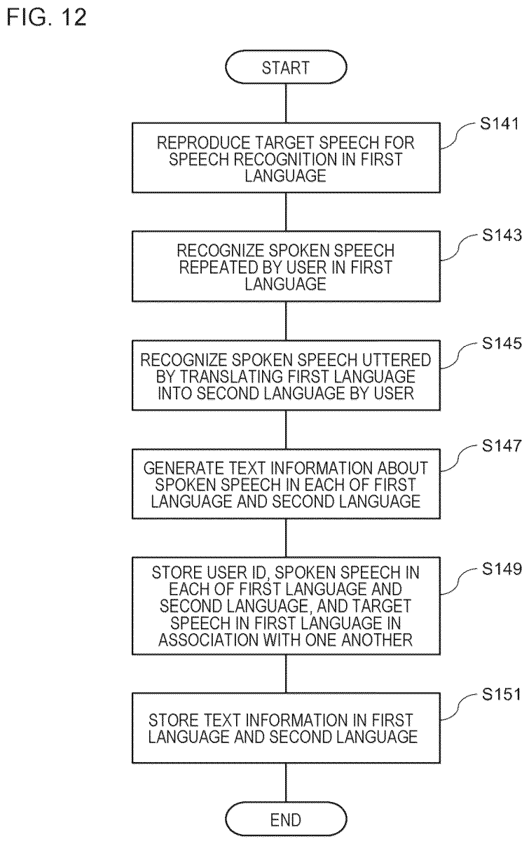

FIG. 12 is a flowchart illustrating an operation example of the speech recognition apparatus 100 according to the present example embodiment. First, the speech reproduction unit 102 divides target speech for speech recognition in the first language into predetermined sections, and reproduces the divided target speech (section speech 12) (step S141). Then, when the user U first repeats the target speech in the first language, the speech recognition unit 104 recognizes the spoken speech 20 repeated by the user U in the first language (step S143). Furthermore, when the user U repeats the target speech in the second language, the speech recognition unit 104 recognizes the spoken speech 20 repeated by the user U in the second language (step S145).

The text information generation unit 106 generates each piece of the text data 30, based on a recognition result 22 of the spoken speech 20 recognized in step S143 and step S145 (step S147).

The storage processing unit 108 stores, as learning data 340 of a translation engine, a user ID, the spoken speech 20 in the first language, the spoken speech 20 in the second language, and the target speech in the first language being reproduced by the speech reproduction unit 102 in association with one another in a storage apparatus 110 (step S149).

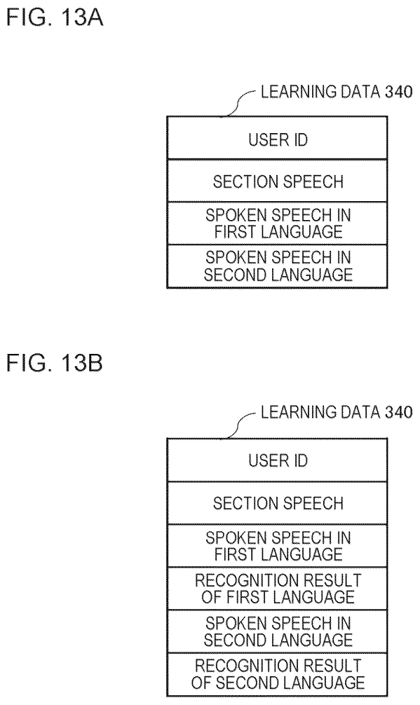

FIGS. 13A and 13B are diagrams each illustrating an example of a data structure of the learning data 340. In the example illustrated in FIG. 13A, the learning data 340 stores, in association with one another, the section speech 12 reproduced by the speech reproduction unit 102, and the spoken speech 20 in the first language and the spoken speech 20 in the second language in the same section. Further, as in the example in FIG. 13B, the learning data 340 may also store a recognition result of each language in association.

Furthermore, the storage processing unit 108 stores, in the storage apparatus 110, the text data 30 in the first language and the text data 30 in the second language that are generated in step S147, in association with each other (step S151).

The present example embodiment can recognize speech information repeated in a first language by the user U who listens to the first language, and speech information spoken by translating the first language into a second language, can generate text information, and, furthermore, can store the spoken speech 20 acquired by repeating the first language, the spoken speech 20 in the second language, and the section speech 12 reproduced by the speech reproduction unit 102 in association with one another. In this way, an effect similar to that in the example embodiment described above can be achieved, and, furthermore, the pieces of information can be used as the learning data 340 of a translation engine, for example.

### Fifth Example Embodiment

A speech recognition apparatus 100 according to the present example embodiment is the same as that in any of the example embodiments described above except for a point that the speech recognition apparatus 100 according to the present example embodiment has a configuration for registering an unknown word.

### <Functional Configuration Example>

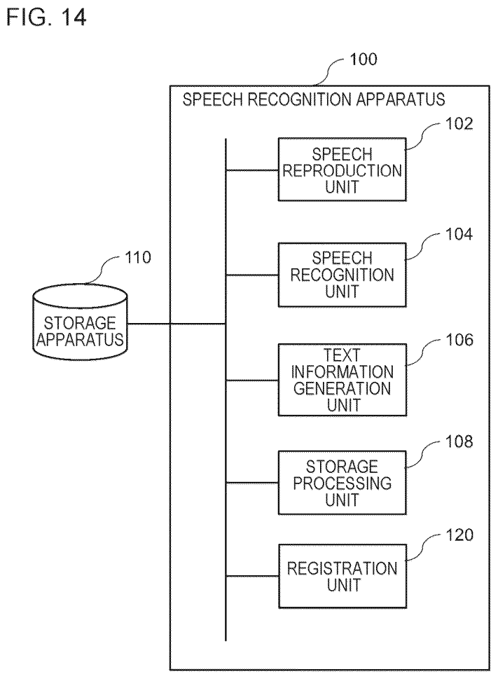

FIG. 14 is a functional block diagram illustrating a functional configuration example of the speech recognition apparatus 100 according to the present example embodiment.

The speech recognition apparatus 100 further includes a registration unit 120 in addition to the configuration of the speech recognition apparatus 100 according to the example embodiments described above.

The registration unit 120 registers, as an unknown word in a dictionary, a word that cannot be recognized by a speech recognition unit 104 among words spoken by a user U.

### <Operation Example>

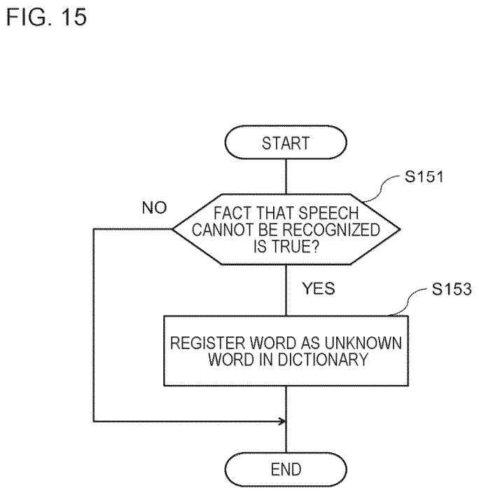

FIG. 15 is a flowchart illustrating an operation example of the speech recognition apparatus 100 according to the present example embodiment. This flowchart starts when, for example, the speech recognition unit 104 cannot recognize spoken speech 20 of the user U in step S103 in FIG. 4 (YES in step S151). Then, the registration unit 120 registers, as an unknown word in a dictionary, a word that cannot be recognized by the speech recognition unit 104 among words spoken by the user U (step S153).

Herein, the dictionary includes both of each model such as a language model 210, an acoustic model 220, and a word dictionary 230 for each user U according to the present example embodiment, and each general-purpose model that is not specialized in a user. A data structure of each dictionary can register speech information in at least any one of different units such as a word, an n-gram word strings and phoneme strings. Thus, speech information about a word that cannot be recognized by the speech recognition unit 104 may be broken down into each unit and registered as an unknown word in a dictionary.

Then, a word registered as an unknown word may be able to be registered by the user U by an editing function similar to that in an example embodiment described later. Alternatively, a word registered as an unknown word may be learned by machine learning and the like.

Since the present example embodiment can register, as an unknown word in a dictionary, a word that cannot be recognized by the speech recognition unit 104, the present example embodiment can achieve an effect similar to that in the example embodiments described above, and, furthermore, can develop a speech recognition engine 200 and improve recognition accuracy.

### Sixth Example Embodiment

A speech recognition apparatus 100 according to the present example embodiment is the same as that in any of the example embodiments described above except for a point that the speech recognition apparatus 100 according to the present example embodiment has a configuration for editing recognition target speech data 10.

### <Functional Configuration Example>

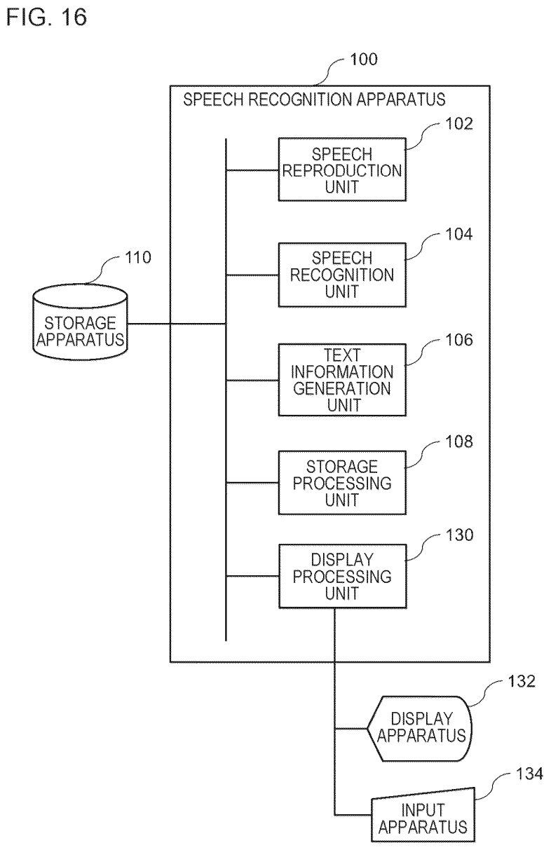

FIG. 16 is a functional block diagram illustrating a functional configuration example of the speech recognition apparatus 100 according to the present example embodiment.

The speech recognition apparatus 100 according to the present example embodiment further includes a display processing unit 130 in addition to the configuration of the speech recognition apparatus 100 according to the example embodiments described above. The display processing unit 130 displays text data 30 generated by a text information generation unit 106 on a display apparatus 132.

The text data 30 may be updated and displayed every time a recognition result 22 is added to the text data 30 by the text information generation unit 106, and the text data 30 in a range associated with reproduction speech until a point in time at which reproduction of all the recognition target speech data 10 or reproduction to a predetermined range is completed may be displayed after completion of the reproduction. The text data 30 may be displayed by receiving an operation instruction of the user U.

Furthermore, the text information generation unit 106 receives an editing operation of the text data 30 displayed on the display apparatus 132, and updates the text data 30 according to the editing operation. The user U can perform the editing operation by using an input apparatus 134 such as a keyboard, a mouse, a touch panel, and an operation switch.

Furthermore, the storage processing unit 108 may update a recognition result of learning data 240 associated with the updated text data 30.

The display apparatus 132 may be included in the speech recognition apparatus 100, or may be an external apparatus. The display apparatus 132 is, for example, a liquid crystal display, a plasma display, a cathode ray tube (CRT) display, an organic electroluminescence (EL) display, and the like.

### <Operation Example>

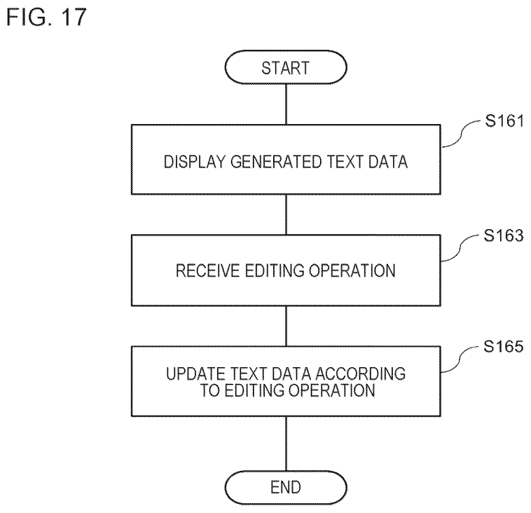

FIG. 17 is a flowchart illustrating an operation example of the speech recognition apparatus 100 according to the present example embodiment.

The display processing unit 130 displays the text data 30 generated by the text information generation unit 106 on the display apparatus 132 (step S161). Then, an editing operation by the user U is received from an operation menu that receives the editing operation (step S163).

On a screen that displays the text data 30, for example, a word having likelihood of the recognition result 22 made by a speech recognition unit 104 equal to or less than a reference value may be, for example, emphasized and displayed in such a way as to be distinguishable from another portion, and the user U may be prompted to check the word. The user U can check whether the emphasized and displayed word is right, and edit the word as necessary.

Then, the text information generation unit 106 updates the text data 30 according to the editing operation received in step S163 (step S165).

According to the configuration, the user U can check the text data 30 transcribed from speech and correct the text data 30 as necessary, and thus accuracy of the transcribed text data 30 can be improved.

While the example embodiments of the present invention have been described with reference to the drawings, the example embodiments are only exemplification of the present invention, and various configurations other than the example embodiments described above can also be employed.

For example, on the display screen of the text data 30 displayed by the display processing unit 130, when specification of a range of text is received through an operation by the user U, the speech reproduction unit 102 may reproduce section speech 12 associated with the text relating to the portion for which the specification is received.

According to the configuration, whether the text data 30 are right can be checked by reproducing the section speech 12 being an original of the text data 30, and, furthermore, the text data 30 can be corrected by the editing operation.

Furthermore, the speech recognition apparatus 100 may further include a determination unit (not illustrated) that determines one of speech recognition engines 200 that are associated with a user indicated by a user ID of learning data and are present by user. The determination unit can determine the speech recognition engine 200 associated with a user ID of learning data, and cause the determined speech recognition engine 200 to learn the learning data.

The invention of the present application is described above with reference to the example embodiments and the examples, but the invention of the present application is not limited to the example embodiments and the examples described above. Various modifications that can be understood by those skilled in the art can be made to the configuration and the details of the invention of the present application within the scope of the invention of the present application.

Note that, when information related to a user is acquired and used in the present invention, this is lawfully performed.

A part or the whole of the example embodiments described above may also be described in supplementary notes below, which is not limited thereto.

1. A speech recognition apparatus, including:
a speech reproduction unit that reproduces, for each predetermined section, target speech for speech recognition being divided for each of the predetermined sections;
a speech recognition unit that recognizes, for each of pieces of the target speech, spoken speech acquired by repeating the target speech by a user;
a text information generation unit that generates text information about the spoken speech, based on a recognition result of the speech recognition unit; and
a storage unit that stores, as learning data, identification information by the user, the spoken speech, and the recognition result corresponding to the spoken speech in association with one another, wherein
the speech recognition unit performs recognition by using a recognition engine that learns the learning data by the user.
   2. The speech recognition apparatus according to supplementary note 1, wherein,
when the speech recognition unit does not recognize the spoken speech repeated by the user within a fixed time, the speech reproduction unit interrupts reproduction of the target speech, and thereafter restarts the reproduction of the target speech from a section at a point in time before a point in time at which the reproduction is interrupted.
   3. The speech recognition apparatus according to supplementary note 2, wherein
the speech reproduction unit does not interrupt reproduction of the target speech when the spoken speech repeated by the user is not recognized in a section different from a section in which the target speech being divided in advance is reproduced.
   4. The speech recognition apparatus according to any one of supplementary notes 1 to 3, wherein
the speech reproduction unit changes a reproduction rate of the target speech in a certain section in response to a speech input rate when the spoken speech repeated by the user is input to a section before the certain section.
   5. The speech recognition apparatus according to any one of supplementary notes 1 to 4, wherein
the storage unit stores the target speech in the predetermined section in association with the spoken speech repeated by the user after the speech reproduction unit reproduces the target speech in the predetermined section.
   6. The speech recognition apparatus according to any one of supplementary notes 1 to 5, wherein
after the speech reproduction unit reproduces target speech for speech recognition in a first language,
the speech recognition unit performs speech recognition on each of the spoken speech in the first language being repeated and the spoken speech uttered by translating the first language into a second language,
the text information generation unit generates the text information about each of the spoken speech in the first language and the spoken speech in the second language, based on a recognition result by the speech recognition unit, and
the storage unit stores, in association with one another, the spoken speech in the first language being repeated by the user, the spoken speech in the second language, and target speech in the first language being reproduced by the speech reproduction unit.
   7. The speech recognition apparatus according to any one of supplementary notes 1 to 6, further including a registration unit that registers, as an unknown word in a dictionary, a word that cannot be recognized by the speech recognition unit among words spoken by the user.
   8. The speech recognition apparatus according to any one of supplementary notes 1 to 7, further including a display unit that displays the text information.
   9. The speech recognition apparatus according to supplementary note 8, wherein the text information generation unit receives an editing operation of the text information displayed on the display unit, and updates the text information according to the editing operation.
   10. A speech recognition method, including:
by a speech recognition apparatus,
reproducing, for each predetermined section, target speech for speech recognition being divided for each of the predetermined sections;
recognizing, for each of pieces of the target speech, spoken speech acquired by repeating the target speech by a user;
generating text information about the spoken speech, based on a recognition result of the spoken speech;
storing, as learning data, identification information by the user, the spoken speech, and the recognition result corresponding to the spoken speech in association with one another; and,
when recognizing the spoken speech, recognizing by using a recognition engine that learns the learning data by the user.
   11. The speech recognition method according to supplementary note 10, including,
by the speech recognition apparatus,
when not recognizing the spoken speech repeated by the user within a fixed time, interrupting reproduction of the target speech, and thereafter restarting the reproduction of the target speech from a section at a point in time before a point in time at which the reproduction is interrupted.
   12. The speech recognition method according to supplementary note 11, including,
by the speech recognition apparatus,
not interrupting reproduction of the target speech when the spoken speech repeated by the user is not recognized in a section different from a section in which the target speech being divided in advance is reproduced.
   13. The speech recognition method according to any one of supplementary notes 10 to 12, including,
by the speech recognition apparatus,
changing a reproduction rate of the target speech in a certain section in response to a speech input rate when the spoken speech repeated by the user is input to a section before the certain section.
   14. The speech recognition method according to any one of supplementary notes 10 to 13, including,
by the speech recognition apparatus,
storing the target speech in the predetermined section in association with the spoken speech repeated by the user after reproducing the target speech in the predetermined section.
   15. The speech recognition method according to any one of supplementary notes 10 to 14, including:
by the speech recognition apparatus,
after reproducing target speech for speech recognition in a first language,
   performing speech recognition on each of the spoken speech in the first language being repeated and the spoken speech uttered by translating the first language into a second language;
   generating the text information about each of the spoken speech in the first language and the spoken speech in the second language, based on a recognition result; and
   storing, in association with one another, the spoken speech in the first language being repeated by the user, the spoken speech in the second language, and target speech in the first language being reproduced.
      16. The speech recognition method according to any one of supplementary notes 10 to 15, further including,
by the speech recognition apparatus,
registering, as an unknown word in a dictionary, a word that cannot be recognized among words spoken by the user.
   17. The speech recognition method according to any one of supplementary notes 10 to 16, further including,
by the speech recognition apparatus,
displaying the text information on a display unit.
   18. The speech recognition method according to supplementary note 17, including,
by the speech recognition apparatus,
receiving an editing operation of the text information displayed on the display unit, and updating the text information according to the editing operation.
   19. A program for causing a computer to execute:
a procedure of reproducing, for each predetermined section, target speech for speech recognition being divided for each of the predetermined sections;
a procedure of recognizing, for each of pieces of the target speech, spoken speech acquired by repeating the target speech by a user by using a recognition engine that learns the learning data by the user;
a procedure of generating text information about the spoken speech, based on a recognition result of the spoken speech; and
a procedure of storing, as learning data, identification information by the user, the spoken speech, and the recognition result corresponding to the spoken speech in association with one another.
   20. The program according to supplementary note 19 for causing a computer to execute:
a procedure of, when not recognizing the spoken speech repeated by the user within a fixed time, interrupting reproduction of the target speech; and
thereafter a procedure of restarting the reproduction of the target speech from a section at a point in time before a point in time at which the reproduction is interrupted.
   21. The program according to supplementary note 20 for causing a computer to execute
a procedure of not performing a procedure of interrupting reproduction of the target speech when the spoken speech repeated by the user is not recognized in a section different from a section in which the target speech being divided in advance is reproduced.
   22. The program according to any one of supplementary notes 19 to 21 for causing a computer to execute
a procedure of changing a reproduction rate of the target speech in a certain section in response to a speech input rate when the spoken speech repeated by the user is input to a section before the certain section.
   23. The program according to any one of supplementary notes 19 to 22 for causing a computer to execute
a procedure of storing the target speech in the predetermined section in association with the spoken speech repeated by the user after reproducing the target speech in the predetermined section.
   24. The program according to any one of supplementary notes 19 to 23 for causing a computer to execute:
after reproducing target speech for speech recognition in a first language,
   a procedure of performing speech recognition on each of the spoken speech in the first language being repeated and the spoken speech uttered by translating the first language into a second language;
   a procedure of generating the text information about each of the spoken speech in the first language and the spoken speech in the second language, based on a recognition result; and
   a procedure of storing, in association with one another, the spoken speech in the first language being repeated by the user, the spoken speech in the second language, and target speech in the first language being reproduced.
      25. The program according to any one of supplementary notes 19 to 24 for further causing a computer to execute
a procedure of registering, as an unknown word in a dictionary, a word that cannot be recognized among words spoken by the user.
   26. The program according to any one of supplementary notes 19 to 25 for further causing a computer to execute
a procedure of displaying the text information on a display unit.
   27. The program according to supplementary note 26 for causing a computer to execute
a procedure of receiving an editing operation of the text information displayed on the display unit, and updating the text information according to the editing operation.

This application is based upon and claims the benefit of priority from Japanese patent application No. 2019-176484, filed on Sep. 27, 2019, the disclosure of which is incorporated herein in its entirety by reference.

### REFERENCE SIGNS LIST

1 Speech recognition system
3 Communication network
4 Microphone
6 Speaker
10 Recognition target speech data
12 Section speech
20 Spoken speech
22 Recognition result
30 Text data
100 Speech recognition apparatus
102 Speech reproduction unit
104 Speech recognition unit
106 Text information generation unit
108 Storage processing unit
110 Storage apparatus
120 Registration unit
130 Display processing unit
132 Display apparatus
134 Input apparatus
200 Speech recognition engine
210 Language model
220 Acoustic model
230 Word dictionary
240 Learning data
340 Learning data
1000 Computer
1010 Bus
1020 Processor
1030 Memory
1040 Storage device
1050 Input/output interface
1060 Network interface

1. A speech recognition apparatus comprising:
a speech reproduction unit that reproduces, for each predetermined section, target speech for speech recognition being divided for each of the predetermined sections;
a speech recognition unit that recognizes, for each of pieces of the target speech, spoken speech acquired by repeating the target speech by a user;
a text information generation unit that generates text information about the spoken speech, based on a recognition result of the speech recognition unit; and
a storage unit that stores, as learning data, identification information by the user, the spoken speech, and the recognition result corresponding to the spoken speech in association with one another, wherein
the speech recognition unit performs recognition by using a recognition engine that learns the learning data by the user.
